(19) United States
(12) Patent Application Publication
(10) Pub. No.: US 2006/0058997 A1
(43) Pub. Date: Mar. 16, 2006

(54) Audio signal identification method and system

(76) Inventor: Karl J Wood, Crawley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/537,129

(22) PCT Filed: Dec. 10, 2003
(86) PCT No.: PCT/IB03/05975

§ 371 Date: Jun. 2, 2005

(30) Foreign Application Priority Data
Dec. 20, 2002 (GB) 0229940
Feb. 21, 2003 (GB) 0303970.8

(51) Int. Cl. G10L 15/20

(52) U.S. Cl. 704/233

(57) ABSTRACT

A method for identifying an audio signal from a set of audio signals. A user preference (106) is received (104). The set of audio signals is concurrently received (108), for example from a number of radio sources. The audio signals are analysed (110) to extract features (112). Audio signals are identified (114) based on a comparison of the user preference (106) and extracted features (112). Optionally, the identified audio signals are outputted (116).

The present invention relates to a method and system for identifying an audio signal from a plurality of audio signals.

There is an increasing amount of audio-visual (AV) content available to consumers and other end users, for example entertainment services delivered by terrestrial, cable, satellite and the Internet. Although new content is available, many consumers remain unaware of such content since they do not have adequate searching aids. Traditional aids such as printed media cannot give prominence to every available source of content—they necessarily focus on a limited set of content, e.g. TV and radio stations receivable in the circulation area of the publication. Such a model cannot fully serve broader non-geographically based content distribution, for example content distributed via satellite or the internet. As an alternative, Electronic Programme Guides (EPG) have been introduced to enable a user to more readily select items; however, these for commercial or other reasons do not cover all content available to the user. In addition, the user needs to make a judgement when selecting an item, for example based on a description of the item—such judgement may be incorrect resulting in a consumer potentially rejecting content which Is of Interest, or vice versa.

Traditionally consumers wish to access content on demand. This type of unplanned use is popular since it requires little planning or effort. A common practice is where users sample the available channels searching for content to watch or listening to. Disadvantages of this process Include the time necessary to sample many channels and the arbitrary chance of success: a typical outcome is to find a suitable item, but then to have missed the start of it; or simply miss an item totally.

Another approach is the use of thematic channels. A user wanting to watch a programme on a specific subject is likely to review channels specialising in that subject matter. Unfortunately, In order to attract a sufficient size of audience, thematic channels tend to be broader in scope than the interests of any particular user. The same is also true for radio channels.

Within an entertainment channel, the subject matter of Items may be described by m eans of m etadata descriptors, for e xample Programme Type PTY codes within Programme Delivery Control (PDC) and Radio Data System (RDS) services defined by the European Broadcasting Union and used by many European broadcasters. A PTY code can be assigned to a programme item to associate it with one of a number of broad classifications, for example to distinguish between Classical and Popular music. As with thematic channels, such categorisation is usually broader than a particular user preference; furthermore, there is no widespread deployment of such metadata services by broadcasters and service providers.

Users are willing to invest in accessing content in the expectation of acquiring content more suited to their particular preferences; preferably, they wish to access content on demand and with a minimum of effort.

It is an object of the present invention to improve on the known art. In accordance with a first aspect of the invention there is provided a method for identifying an audio signal from a plurality of audio signals, the method comprising:
receiving a user preference;
concurrently receiving the plurality of audio signals;
analysing the audio signals to extract features; and
Identifying a first audio signal based on a comparison of the user preference and extracted features.

In accordance with a second aspect of the invention there is provided a system for Identifying an audio signal from a plurality of audio signals comprising:
a receiving device operable to receive a user preference;
audio input means operable to concurrently receive the plurality of audio signals;
processing means operable to analyse the audio signals to extract features and to identify a first audio signal based on a comparison of the user preference and extracted features.

Owing to the Invention It is possible to identify an audio signal corresponding to a user preference from a plurality of audio signals in an efficient and accurate manner. The audio signals may be digital or analogue.

Advantageously, the first audio signal Is output; for example a currently available audio signal which substantially matches the user preference. Ideally, analysis of the audio signals is performed continuously and further identifies a second audio signal based on a comparison of the user preference and extracted features. In this way, the method identifies additional audio signals for possible future use. Preferably and according to a pre-defined rule, the outputting switches from the first to the second audio signal. The rule Is determined according to any suitable criterion, for example operational performance or user request. Advantageously, the method stores the second audio signal and when the outputting switches from the first to the second audio signal, it recalls the second audio signal from the store. As an example, this enables the outputting of the first audio signal to be completed prior to commencing the outputting of the second audio signal. Ideally, the storing of the second audio signal begins upon identifying the second signal. In this way, the outputting of the second audio signal can be commenced substantially at the start of the second audio signal. A further advantage is gained by storing the plurality of audio signals. Such storing facilitates an enhanced performance, for example allowing the audio signals to be outputted in an order different to that in which the signals were identified. Furthermore, a user can affect the outputting of the stored audio signals, for example by skipping a presently outputted audio signal. He can also change his preference and request a re-analysis of the stored audio signals according to the new preference.

Advantageously, receiving a user preference comprises receiving said preference from a user interface. This permits a user to Identify his preference by any suitable user interface method. Alternatively, receiving a user preference comprises receiving said preference from a store. In this case, a user preference is obtained by reference to one or more stored parameters, which parameters were previously determined, for example by monitoring prior usage. Alternatively, the stored parameters are fixed and represent a static user preference. In certain embodiments, the method comprises translating said user preference to features.

The extracted features comprise inherent features of audio signals. For audio signals comprising musical content, the inherent features are musical features.

An advantage of the present invention is that the user is not required to review the audio signals in order to perform the identification of an audio signal from a plurality of audio signals. Furthermore, the invention is applicable to the identification of any audio signal Independently of or in co-operation with categorised content of service providers, broadcasters and the like. Moreover, suitable audio signals include those associated with digital networked services (e.g. internet radio stations, AV streaming, etc.) as well as traditional television and radio services. In addition, the invention supports substantIally real-time identification of audio signals and the outputting thereof.

Embodiments of the Invention will now be described, by way of example only, with reference to the accompanying drawings in which:

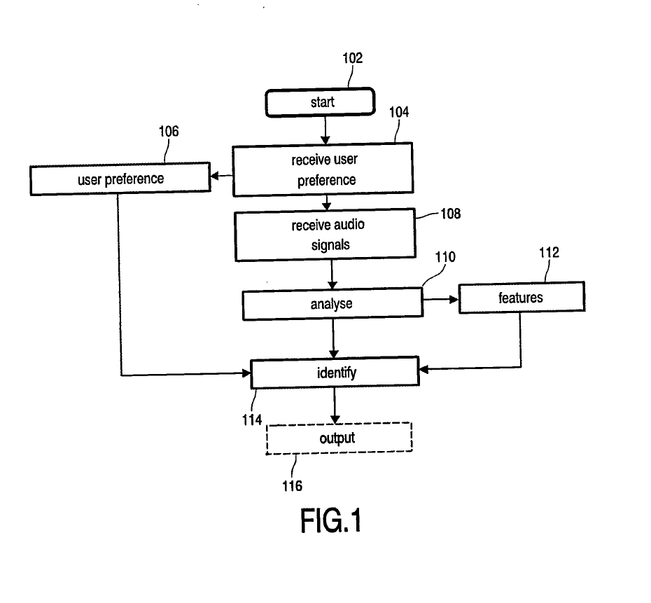

FIG. 1 is a flow diagram of a method for Identifying an audio signal from a plurality of audio signals;

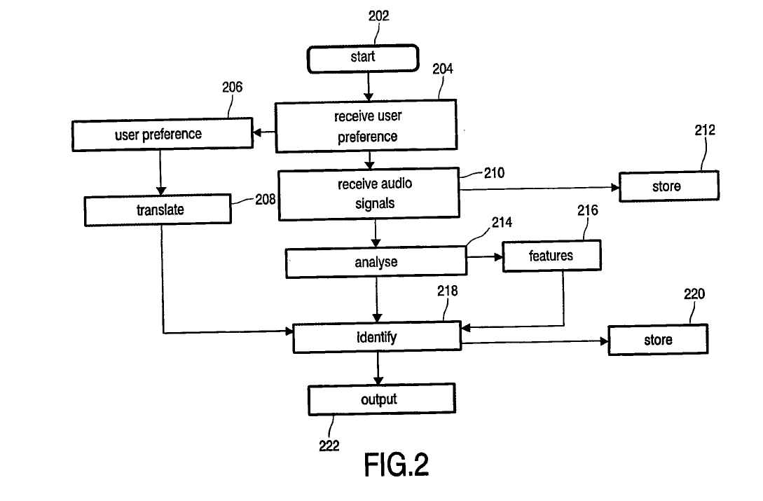

FIG. 2 is a flow diagram of the method of FIG. 1 comprising further steps;

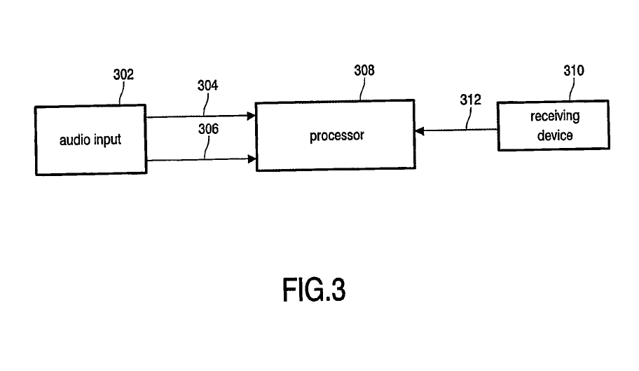

FIG. 3 is a schematic representation of a system for identifying an audio signal from a plurality of audio signals;

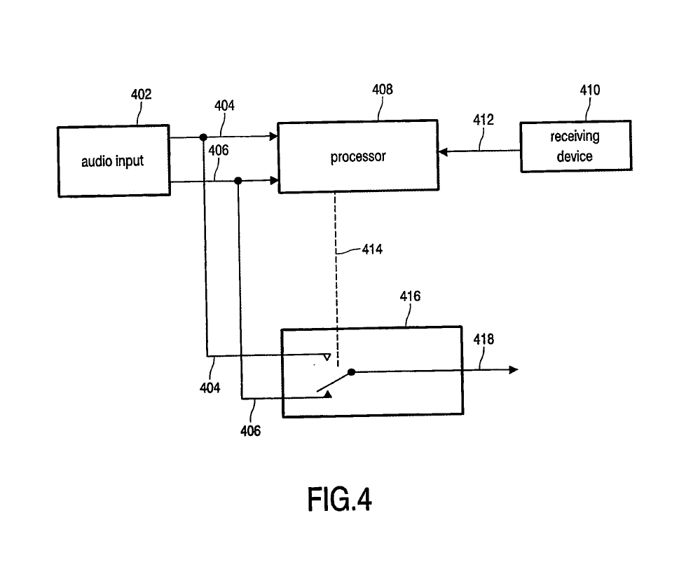

FIG. 4 is a schematic representation of the system of FIG. 3 further including an output device for the outputting of an identified audio signal;

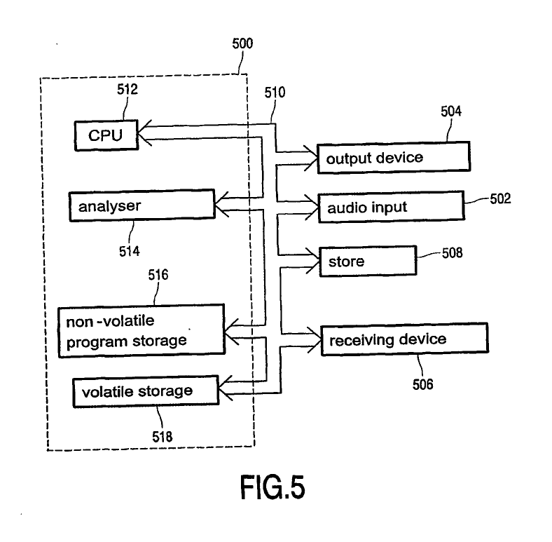

FIG. 5 is a schematic representation of a second embodiment of the system for identifying an audio signal from a plurality of audio signals depicting a preferred processing means;

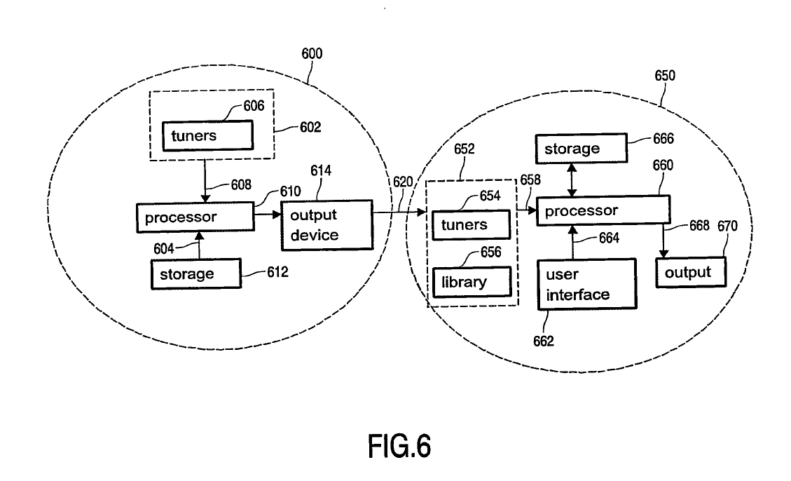

FIG. 6 is a schematic representation of a first application of the system of FIG. 5 for identifying an audio signal from a plurality of audio signals in which the processing is performed by a service provider apparatus and a user apparatus; and

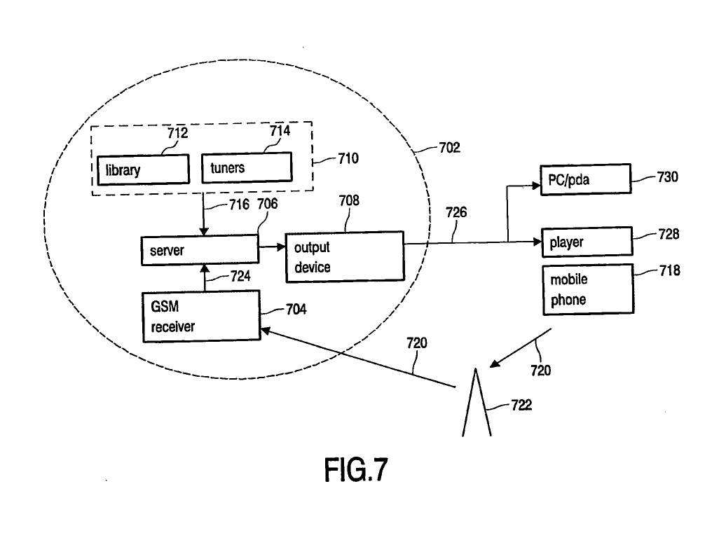

FIG. 7 is a schematic representation of a second application of the system of FIG. 5 for Identifying an audio signal from a plurality of audio signals in which the processing is performed by a network service provider.

FIG. 1 shows a flow diagram of a method for identifying an audio signal from a plurality of audio signals. The method starts at 102. A user preference 106 is received 104. The plurality of audio signals is concurrently received 108 such that the audio signals are made available for analysis 110 to extract features 112. The analysing may be performed sequentially on each audio signal in turn or concurrently on the signals, or any combination. Ideally, for substantially real-time applications, concurrent analysis Is performed on the audio signals. An audio signal is then identified 114 based on a comparison of the user preference and the extracted features. The Identified audio signal is, optionally (as depicted by the dashed outline), outputted 116. Preferably analysis of the audio signals is performed continuously and additional audio signals are further identified. Where outputting is intended, according to a pre-defined rule the outputting switches from one identified audio signal to another. Any suitable pre-defined rule may be determined. An example Is a rule related to an identified audio signal such as being based on the end of the currently output identified audio signal. Another example is a rule responsive to user input, for example where the user requests to skip the remainder of the currently output identified audio signal.

The term ‘audio signals’ as used herein is associated with content comprising one or more audio signals, including entertainment channels (e.g. radio stations, TV channels and Internet channels), programme items within entertainment channels (e.g. radio and TV shows) and discrete items (e.g. music tracks. and similar short Items). Features extracted from audio signals comprise inherent features of the audio signals. The term ‘inherent features’ means those features of an audio signal which comprise the attributes of the audio signal, for example musical features; as distinct from other features such as those which are merely associated with the audio signal, such as metadata or volume level. Examples of musical features include musical key, pitch and tempo. A received user preference identifies one or more features which together represent the user preference. A suitable user preference may be received from an interface (for example a user interface) or from a store. The latter method is appropriate where, for example, a previously defined user preference is utilised more than once, thereby saving user time and effort.

FIG. 2 shows a flow diagram of the method of FIG. 1 comprising further steps. The method starts at 202 and a user preference 206 is received 204. The plurality of audio signals is concurrently received 210 and these are stored 212. The audio signals are analysed 214 to extract features 216. Since the audio signals are stored, analysis can be performed on each audio signal in turn which may potentially save cost compared to concurrent analysis. This approach is particularly suitable for applications which identify audio signals as a background process rather than substantially real-time. Audio signals are then identified 218 based on a comparison of the user preference and the extracted features. The figure shows the user preference 206 translated 208 into one or more features. An identified signal Is then stored 220 and identified signals are output 222. Outputting switches from the current audio signal to the next audio signal recalling the next audio signal from storage. Preferably, the storing of an identified audio signal begins upon Identifying the signal. This allows for example to commence outputting an identified audio signal substantially from its starting point.

FIG. 3 shows a schematic representation of a system for Identifying an audio signal from a plurality of audio signals. The system comprises a receiving device 310 for receiving a user preference 312, an audio Input means 302 to concurrently receive two audio signals 304, 306 and a processor 308 to analyse the audio signals to extract features and to identify an audio signal based on a comparison of the user preference and extracted features. The receiving device 310 can be a user interface, a wired interface or a wireless interface. For example, the receiving device 310 may interface to a store containing the user preference. Although only two audio signals 304, 306 are shown, in general a system will be capable of receiving a suitable number of audio signals for the desired application. The audio signals 304, 306 are analogue or digitally coded and originate from any suitable source, including broadcast radio (e.g. AM, FM, DAB), television (e.g. terrestrial, cable, satellite) and digital networked services (e.g. GSM, 3G, Internet). Internet delivered services include radio and TV services In downloadable and streamed formats. The audio input means 302 provides the capability to receive and make available audio signals 304, 306 to the processor 308. Typically, the audio input means 302 comprises a receiving means for each audio input, for example one or more analogue FM radio tuners and an Internet tuner (e.g. to access URLs which stream radio content). Optionally, the processor 308 includes the capability to control a tuner so that alternative audio signals can be received by the tuner. The audio input means 302 optionally includes means to receive library content, such as a user's C D collection. Where an analogue audio signal is received this may, to facilitate subsequent processing, be converted to digital format either by the audio input means 302 or the processor 308.

The processor 308 analyses the audio signals to extract features. The approach used for analysis will depend on the overall application. The invention supports applications which are substantially real-time and also those which are not. In the former case it is clearly prudent to minimise the time used for analysis. Since the features are inherent to the audio signals, faster (analysis) processing may not minimise analysis time. Generally, for substantially real-time applications, improved performance is achievable by having one analyser per received audio signal, as further discussed in relation to FIG. 5 below. Conversely, for non real-time applications adequate performance may be obtained by sharing an analyser between two or more audio signals. The processor 308, having analysed and extracted features, then identifies an audio signal based on a comparison of the user preference 312 and extracted features. The invention supports one-shot analysis and identification, for example switching on a radio and automatically identifying a station whose audio signal currently corresponds to the user's preference. The invention also supports a continuous analysis and identification, as further discussed below.

FIG. 4 shows a schematic representation of the system of FIG. 3 further including an output device for the outputting of an identified audio signal. The system comprises a receiving device 410 for receiving a user preference 412, an audio Input means 402 to concurrently receive two audio signals 404, 406, a processor 408 to analyse the audio signals to extract features, to Identify an audio signal based on a comparison of the user preference and extracted features and to control 414 an output device 416 for outputting 418 the identified audio signal. A useful aspect is the ability to output identified audio signals. This outputting is managed by the processor controlling an output device. The physical output device may be integrated within the processor itself such that the identified audio signals output from the processor are determined by the processor controlling the output device. In the embodiment, a separate output device 416 is shown comprising a changeover switching arrangement controlled 414 by the processor 408. For example, where audio signal 404 is initially identified by the processor, the switching arrangement is controlled to select audio signal 404 to be outputted 418. The processor can be arranged to continuously analyse and identify audio signals; In this case the processor is able, following an initial Identification, to identify further audio signals based on a comparison of the user preference and extracted features. According to a pre-defined rule, the outputting is then able to be switched from one Identified audio signal to another Identified audio signal. Any suitable rule can be defined, for example switching at the end of the currently output audio signal or switching to output an audio signal immediately it is first identified. The rule used will depend on the performance desired from the system. Further measures can be used in conjunction with a suitable rule to enhance performance, as discussed below. In respect of the embodiment of FIG. 4, a suitable rule could be to switch the output device when an audio signal is identified. The rule Is contained in the processor 408.

Presuming audio signal 404 is first identified, the processor then (according to the rule) controls 414 the output device 416 to select audio signal 404 to be output 418. The processor continues analysing the audio signals 404 and 406, and during this time continually identifies audio signal 404. Subsequently, audio signal 406 is identified and the processor then (according to the rule) controls 414 the output device 416 to switch from audio signal 404 to audio signal 406.

FIG. 5 shows a schematic representation of a second embodiment of the system for identifying an audio signal from a plurality of audio signals depicting a preferred processing means. Due to a more flexible implementation extra features over those of FIG. 4 are enabled. The figure shows an example of a system comprising processor 500, audio input means 502, output device 504, receiving device 506 and store 508 all interconnected by bus 510. The audio input means 502 receives a plurality of audio signals, for example using one or m ore tuners to receive audio signals associated with standard broadcast and network delivered services. The number and types of tuners will depend on the application; examples of tuners include those capable to receive terrestrial radio broadcasts (including AM, FM, DAB), terrestrial TV broadcasts (analogue and digital), satellite TV and radio broadcasts, cable TV and radio channels, mobile phone communications (e.g. GSM, and 3G systems), and network services (e.g. Internet radio and other audio-visual services). The processor 500 comprises a CPU 512, analyser 514, non-volatile program storage (e.g. ROM) 516 and volatile storage (e.g. RAM) 518, interconnected by bus 510. The audio input means 502 receives a plurality of audio signals and places these onto the bus 510. The analyser 514 analyses the audio signals to extract features which are then stored. The analyser may perform the analysis sequentially for each audio signal in turn. For efficiency, it is preferable that each audio signal is analysed concurrently. The analyser can be Implemented using any suitable means, preferably using one or more dedicated circuits, for example ASIC or CPU; each circuit may be shared among several audio input means devices (e.g. tuners); ideally each circuit is allocated to one device. In some applications, for example those which do not operate in real-time, the function of the analyser 514 may instead be performed by CPU 512. The non-volatile program storage contains program instructions for the CPU 512 and, where software driven, also the analyser.

The receiving device 506 receives a user preference which it then places on bus 510. The receiving device may be part of a user interface; any user interface which enables a user to Interact and determine a user preference Is suitable. Alternatively, the receiving device may simply receive the user preference via an alternative entity, such as store 508 or a (wired or wireless) network Interface; examples of these are discussed in relation to FIGS. 6 and 7 below. Any suitable method may be used to determine a user p reference including cases where the user implicitly provides a preference; an example is where one or more features of the audio signal of a presently tuned radio station represent the user preference. The CPU 512 identifies an audio signal based on a comparison of the user preference and extracted features. The user preference may have been received in a format which requires translating to features for audio signal Identification; in the case where the receiving device is not able, the translation is performed by CPU 512. The CPU 512 then controls the outputting of identified audio signals by forwarding selected Identified audio signals via bus 510 to output device 504. In turn the output device 504 may further process the audio signals according to interfacing needs, for example by converting them to another format (e.g. digital-analogue conversion, compression/decompression, etc.).

The CPU 512 also interacts with store 508. The store 508 is of any suitable type including those utilising magnetic and optical media. Preferably the store is operable to simultaneously write and read, for example a hard disk drive. The store 508 can be used for any combination of the following purposes. One purpose is to store extracted features and those features corresponding to the user preference. Another purpose Is to log the identities of audio signals; for example radio stations whose audio signals were identified. Such a log can be used to direct the user to access those stations in the expectation that they contain content which the user prefers; this capability can be further enhanced if the records also indicate times of d ay when the audio signals were identified. The log may also be used to help refine the user preference, for example in the case where too many or too few audio signals were identified, by for example selecting one or more records to be representative of the user preference. A further purpose is to store identified audio signals. This permits outputting the entirety of an identified audio signal. Furthermore, for real-time applications, the output order of the identified audio signals can be adjusted. As a n example, the processor 500 identifies audio signals from received radio services and arranges to output the signals in most recent order so as to emulate a radio service corresponding to the user preference. W hile the present identified audio signal is being outputted, the processor may identify a further audio signal which is then stored and is promoted to the start of the list of identified audio signals awaiting output. Still further, a set of stored identified audio signals can be reviewed by the user; In addition, the set can be edited or even re-analysed against a revised user preference, for example refining (narrowing) the user preference and thereby reducing the size of the set. A yet further purpose is to store the received audio signals. This has the benefit of permitting non-real-time analysis of the audio signals; such analysis is appropriate for applications which identify audio signals as a background function and can save cost by sharing analysing means between more than one audio signal. A further benefit Is that the received audio signals can be analysed using a plurality of user preferences, for example where a user Is searching under more than one preference. The bus 510 configuration described above and shown in the figure facilitates these various storing options. It is to be noted that a system embodying the invention can be distributed, for example the functions of the processor 500 as described above can be performed at a service provider or at the user side or a combination of these locations.

FIG. 6 shows a schematic representation of a first application of the system of FIG. 5 for Identifying an audio signal from a plurality of audio signals in which the processing is performed by a service provider apparatus and a user apparatus. A service provider apparatus 600 comprises an audio input means 602 (which comprises tuners 606) concurrently receiving audio signals 608, for example from broadcast service providers as described above.

A user preference 604 is received from storage 612 and represents the preference of a group of users. The preference may be determined by the service provider in any suitable way, for example through market research. A processor 610 analyses the audio signals to extract features and identifies audio signals based on a comparison of the user preference 604 and extracted features. An example of an implementation of processor 610 is given above in relation to referenced item 500 of FIG. 5 and its associated description. Identified audio signals 620 are output under control of the processor 610 by output device 614, which device for example Is a broadcast FM radio transmitter. As an example, the service provider provides one or more thematic audio signals channels (corresponding to the preference of a group of users) derived from audio signals received by tuners 606. The user apparatus 650 includes audio input means 652 comprising tuners 654 and library reader 656. The tuners 654 receive audio signals 620 from the service provider 600 (and possibly also audio signals from elsewhere, including radio and TV broadcasts and internet services). The library reader receives locally generated audio signals from for example a media player, these signals can be used to identify further audio signals in the case where no identified audio signals are available from the tuners 654. The received audio signals 658 are analysed and identified In the processor 660 according to a user preference 664 received from user interface 662. The processor utilises storage 666 according to the requirements of the application (as discussed above) and controls the output of identified audio signals 668 to output device 670. An example of an implementation of processor 660 is given above in relation to referenced item 500 of FIG. 5 and its associated description. An advantage of this embodiment is that the user apparatus can be made more economically and operate more efficiently for a given user preference, since less audio signals are required to be received and processed by the user apparatus. The present embodiment is particularly suited to broadcast communications methods. Clearly, the embodiment includes the situation wherein the processing is performed exclusively by the user apparatus on audio signals received from regular broadcast and network service providers.

FIG. 7 is a schematic representation of a second application of the system of FIG. 5 for Identifying an audio signal from a plurality of audio signals in which the processing is performed by a network service provider. In this embodiment, a network service provider apparatus 702 includes an audio input means 710 (comprising library reader 712 and tuners 714) for receiving to audio signals 716 which are analysed and identified by server 706 according to a user preference 724. An example of an implementation of server 706 is given above in relation to the combination of referenced items 500 and 508 of FIG. 5 and their associated descriptions. In the embodiment, the user preference 724 is received by GSM receiver 704 in the form of an SMS message 720 sent from a mobile phone 718 via a GSM network 722. The server controls the outputting of identified audio signals 726 to the output device 708, which device may for example be an H TTP p ort. The user can then receive the identified audio signals 726 and play them on player 728 and/or download them onto a device 730 being a PC, PDA, MP3 Jukebox or the like. This embodiment has the advantage of not requiring specialised user equipment; existing products such as MP3 players and PCs can be used. The embodiment is particularly suited to peer-peer communications methods, including physical media distribution (for example, CD-ROMs by mail).

The foregoing method and implementation are presented by way of example only and represent a selection of a range of methods and implementations that can readily be identified by a person skilled In the art to exploit the advantages of the present invention.

In the description above and with reference to FIG. 1 there is disclosed a method for identifying an audio signal from a set of audio signals. A user preference 106 is received 104. The set of audio signals is concurrently received 108, for example from a number of radio sources. The audio signals are analysed 110 to extract features 112. Audio signals are identified 114 based on a comparison of the user preference 106 and extracted features 112.

Optionally, the identified audio signals are outputted 116.

1. A method for identifying an audio signal from a plurality of audio signals, the method comprising:
receiving (104) a user preference;
concurrently receiving (108) the plurality of audio signals;
analysing (110) the audio signals to extract features; and
identifying (114) a first audio signal based on a comparison of the user preference and extracted features:

2. A method as claimed in claim 1 and further comprising outputting (116) said first audio signal.

3. A method as claimed in claim 1 or 2, wherein said analysing the audio signals is performed continuously and further identifying a second audio signal based on a comparison of the user preference and extracted features.

4. A method as claimed in claims 2 and 3, wherein, according to a pre-defined rule, said outputting switches from said first to said second audio signal.

5. A method as claimed in claim 4 and further comprising storing (220) said second audio signal and when said outputting switches from said first to said second audio signal recalling said second audio signal from the store.

6. A method as claimed in claim 5, wherein said storing of said second audio signal begins upon identifying said second signal.

7. A method as claimed in any of claims 1 to 5 and further comprising storing (212) the plurality of audio signals.

8. A method as claimed in any preceding claim, wherein said receiving a user preference comprises receiving said preference from a user Interface.

9. A method as claimed In any of claims 1 to 7, wherein said receiving a user preference comprises receiving said preference from a store.

10. A method as claimed In any preceding claim, wherein the extracted features comprise inherent features.

11. A method as claimed in claim 10, wherein the Inherent features are musical features.

12. A method as claimed in any preceding claim and further comprising translating (208) said user preference to features.

13. A system for identifying an audio signal from a plurality of audio signals comprising:
a receiving device (310) operable to receive a user preference;
audio input means (302) operable to concurrently receive the plurality of audio signals;
processing means (308) operable to analyse the audio signals to extract features and to Identify a first audio signal based on a comparison of the user preference and extracted features.

14. A system as claimed in claim 13 and further comprising an output device (416) for outputting said first audio signal, said processing means operable to control said output device.

15. A system as claimed In claim 13 or 14, wherein the processing means Is operable to continuously analyse the audio signals and to further Identify a second audio signal based on a comparison of the user preference and extracted features.

16. A system as claimed in claims 14 and 15, wherein, according to a pre-defined rule, the processing means is operable to control said output device to switch from said first to said second audio signal.

17. A system as claimed in any of claims 13 to 16 and further comprising storage means (508).

18. A system as claimed in claim 17 wherein said storage means is operable to simultaneously write and read.

19. A system as claimed in any of claims 13 to 18 wherein said receiving device is a user interface (662).

20. A system as claimed in any of claims 13 to 18 wherein said receiving device is a wireless interface (704).

21. A record carrier comprising software operable to carry out the method of any of the claims 1 to 12.

22. A software utility configured for carrying out the method steps as claimed in any of the claims 1 to 12.

23. A system including processing means, said processing means being directed in its operations by a software utility as claimed in claim 22.
